(19) United States
(12) Patent Application Publication
(10) Pub. No.: US 2026/0269341 A1
(43) Pub. Date: Sep. 10, 2026

(54) MOBILE POWER SUPPLY

(71) Applicant: Senliao Lou, Yuyao (CN)

(72) Inventor: Senliao Lou, Yuyao (CN)

(21) Appl. No.: 19/662,185

(22) Filed: Apr. 29, 2026

(30) Foreign Application Priority Data
Apr. 3, 2026 (CN) 202610437567.8

(51) Int. Cl. H01M 10/44; B60S 5/00; H01M 10/48; H02J 7/60; H02J 7/82; H02J 7/90

(52) U.S. Cl. CPC H01M 10/44; B60S 5/00; H01M 10/48; H02J 7/60; H02J 7/82; H02J 7/90; H01M 2220/20

(57) ABSTRACT

The present invention discloses a mobile power supply, comprising a box body assembly. An emergency start power supply is installed in the box body assembly, the emergency start power supply is provided with an air pump module and an inverter module, a large-capacity battery is arranged in the emergency start power supply, and the emergency start power supply is provided with a bidirectional USB module capable of fast charging and discharging. The emergency start power supply with the large-capacity battery is adopted for use together with the air pump module and the inverter module, has the USB fast charging and discharging functions, and also has the functions of zero-current-consumption circuit design, battery expansion detection, and three-stage temperature detection protection, so that the emergency start power supply can cope with various situations encountered during use, form setting or detection for various situations, and form an effective feedback and coping mechanism.

### CROSS-REFERENCE TO RELATED APPLICATIONS

This application claims priority to Chinese Patent Application No. 202610437567.8, filed on April 3, 2026, which is hereby incorporated by reference in its entirety.

### TECHNICAL FIELD

The present invention relates to a mobile power supply.

### BACKGROUND

Vehicles, yachts, etc. are commonly used means of transportation. Such means of transportation are internally equipped with storage batteries (mostly of which are 12 V lead-acid batteries, but some are 24 V lead-acid batteries), and serve as electric output devices of the means of transportation to meet basic power demands such as power plant ignition, radio and illuminating lamps. However, it is easy for the means of transportation to break down when the power of the storage batteries is exhausted after long-term use or the storage batteries seriously lack of power at low temperature in winter. Thus, it is necessary to electrify the broken-down vehicle to realize the emergency start of the means of transportation.

A common way of electrification is to find other vehicles to help electrification, or use an emergency start power supply device to help to start the means of transportation. For convenience, selecting the emergency start power supply device to electrify the means of transportation is the simplest and most efficient way. During operation, positive and negative electrode clips on the emergency start power supply device are correspondingly clamped to the positions of the positive and negative electrodes of the storage batteries of the means of transportation, and then the vehicle is started to complete the operation of starting by electrification.

Optimization design of the emergency start power supply device is a very meaningful job. In addition to meeting the electrification demands, the emergency start power supply device should also consider defects that may exist or easily occur in the device. These defects are the directions of product optimization. These defects affect the convenience and safety of use of the emergency start power supply device. These defects include:

(1) When the emergency start power supply device is started, the positive and negative electrode clips connected thereto will generate magnetism after being energized. Once the positive and negative electrode clips are adsorbed together for a long time, it is easy to cause short circuit of the emergency start power supply device and damage of an internal circuit of the emergency start power supply device.

(2) There is a lack of a protection mechanism for the charging and discharging of the batteries inside the emergency start power supply device, and it is easy to damage the emergency start power supply device itself.

(3) The emergency start power supply device lacks a response mechanism to own unfavorable situations, including a coping mechanism for the change of the temperature and the structural form of the batteries. For example, the temperature of the battery is too low and thus the battery cannot be used, the battery is damaged by ultrahigh temperature, the battery expands and bulges, and the battery burns.

Therefore, the structure is improved and a control system matched with the structure is added in combination with a conventional emergency start power supply device, so as to cope with the use under various situations.

### SUMMARY

In view of the above defects in the prior art, the purpose of the present invention is to provide a mobile power supply.

The technical solution of the present invention is as follows: A mobile power supply comprises a box body assembly, wherein an emergency start power supply is installed in the box body assembly, the emergency start power supply is provided with an air pump module and an inverter module, a large-capacity battery is arranged in the emergency start power supply, and the emergency start power supply is provided with a bidirectional USB module capable of fast charging and fast discharging.

Further, the mobile power supply comprises a controller, wherein the controller is connected with an automobile battery voltage detection module, a one-key self-locking zero-power-consumption switch module, a battery balance management module, a temperature protection control module, a battery bulging detection module, a start output module, the bidirectional USB module, an LED illuminating lamp, an LED lamp switch module, a power and information display module, the inverter module and the air pump module; the automobile battery voltage detection module is connected with the start output module; the start output module is connected with a fuse module; the fuse module is connected with the bidirectional USB module; the battery balance management module is connected with the one-key self-locking zero-power-consumption switch module; and the battery is connected with the battery balance management module, the battery bulging detection module, the temperature protection control module, the inverter module and the air pump module.

Further, the controller is provided with a voltage detection control module, and an input end of the voltage detection control module is connected with an output end of the automobile battery voltage detection module; the controller is provided with an on/off management module, and an input end of the on/off management module is connected with an output end of the one-key self-locking zero-power-consumption switch module; the controller is provided with a charging monitoring module, and the charging monitoring module is connected with the battery balance management module; the controller is provided with a battery low-temperature heating control module and a battery temperature detection module, an output end of the battery low-temperature heating control module is connected with an input end of the temperature protection control module, and an input end of the battery temperature detection module is connected with an output end of the temperature protection control module; the controller is provided with a start control module, and the start control module is connected with the start output module; the controller is provided with a USB control module, a charging control module and an LED illuminating lamp control module; the USB control module and the charging control module are connected with the bidirectional USB module; the LED illuminating lamp is connected with the bidirectional USB module; an input end of the LED illuminating lamp control module is connected with an output end of the LED lamp switch module; the controller is provided with a power and information display control module, and the power and information display control module is connected with the power and information display module; the controller is provided with an air pump data detection and communication module, and the air pump data detection and communication module is connected with the air pump module; and the controller is provided with an inverter data detection and communication module, and the inverter data detection and communication module is connected with the inverter module.

Further, the controller has a magnetization function; the battery controls output through a relay switch with a magnetization function driven by the controller; after a positive electrode and a negative electrode of the emergency start power supply are correctly connected with an automobile, large current can be outputted and a magnetic field after the large current is generated can be optimally demagnetized; and magnetic steel is arranged inside a relay.

Further, the emergency start power supply is switched on and off through detection of battery voltage.

Further, the battery temperature detection module comprises three temperature detection units, and the temperature detection units are attached to a surface of the battery to perform multi-stage detection and protection on the battery.

Further, the three temperature detection units are a first temperature detection unit, a second temperature detection unit and a third temperature detection unit; and when the first temperature detection unit monitors that battery temperature reaches a set value, the battery temperature detection module transmits a signal to the battery balance management module, and the battery balance management module controls and adjusts the output power of the battery.

Further, when the first temperature detection unit loses a function due to an uncontrollable reason and the battery temperature reaches the set value, the second temperature detection unit starts a monitoring function and feeds back to the battery balance management module.

Further, when both the first temperature detection unit and the second temperature detection unit lose functions, the third temperature detection unit starts to operate, and once monitoring that the battery temperature reaches the set value, the third temperature detection unit automatically cuts off the output function of the emergency start power supply, serves as a fuse of the emergency start power supply, and is non-recoverable.

Further, no matter whether the battery temperature reaches the set value due to charging, discharging or low temperature, after the battery balance management module receives information that the temperature fed back by the first temperature detection unit or the second temperature detection unit reaches the set value, the battery balance management module issues an instruction to stop external output or internal input of the emergency start power supply, and automatically recovers the input or output function after the battery temperature returns to a normal range.

Further, the battery low-temperature heating control module comprises heating plates arranged between surfaces of the battery, and the heating plates are connected to a positive electrode and a negative electrode of the battery through the battery balance management module; and the heating plates are attached to an outer surface of the battery and have flame-retardant and insulating properties.

Further, after the battery balance management module receives low-temperature feedback, the battery low-temperature heating control module starts to operate; the heating plates start to generate heat; and when the battery temperature reaches a set required value for normal operation, the battery low-temperature heating control module stops operating.

Further, the battery bulging detection module comprises a first sheet metal and a second sheet metal; the battery is installed in a battery shell composed of a battery upper shell and a battery lower shell; the first sheet metal is fixed on an upper surface of the battery; the second sheet metal is fixed on an inner wall of the battery upper shell; when the first sheet metal is in contact with the second sheet metal, the feedback is sent to the battery balance management module; the battery balance management module determines that the battery expands and bulges, and timely stops the input or output function of the emergency start power supply; and the stopping behavior is non-recoverable.

Further, the one-key self-locking zero-power-consumption switch module automatically closes all input and output functions when the emergency start power supply stops operating, so as to achieve zero-current energy consumption.

Further, the one-key self-locking zero-power-consumption switch module comprises: a key switch circuit, a shutdown detection circuit, a self-locking loop circuit and a main control module; the key switch circuit comprises a key SW3, the key SW3 is connected with a power supply positive electrode BAT+, and the shutdown detection circuit is connected in series between the power supply positive electrode BAT+ and an input end of the main control module through the key SW3; the self-locking loop circuit comprises an MOS tube Q15, a triode Q16, a resistor R84, a resistor R85 and a resistor R87; a collector of the triode Q16 is connected with a gate of the MOS tube Q15 through the resistor R84; a source of the MOS tube Q15 is connected with the power positive pole BAT+; the resistor R85 and the resistor R87 connected in series successively are connected between a drain of the MOS tube Q15 and the triode Q16 to form a self-locking loop; a common end of the resistor R85 and the resistor R87 is connected to an output end of the main control module;

The key SW3 is connected to the base of the triode Q16 through a voltage dividing resistor, and when the key SW3 is pressed, the triode Q16 is saturated and conducted, and the MOS transistor is conducted to achieve start; and when the key SW3 is pressed again, the shutdown detection circuit detects voltage and transmits the voltage to the main control module, the main control module controls the output end to output a low voltage level, the triode Q16 is cut off, and the MOS transistor Q15 is cut off to complete shutdown.

Further, the on/off management module comprises a resistor R78, a resistor R79 and a capacitor C41, the resistor R78 is connected in series between the input end of the main control module and the key SW3, and the resistor R79 and the capacitor C41 are both connected in parallel between the input end of the main control module and the ground;

A resistor R83 and a capacitor C43 are connected in parallel between the grid and the source of the MOS transistor Q15;

An emitter of the triode Q16 is grounded, and a resistor R88 is connected in series between the base and the emitter of the triode Q16; a resistor R89 is connected in series between the common end of the resistor R85 and the resistor R87 and the ground;

The drain of the MOS transistor Q15 is connected to a VDD end of the main control module through a diode D12, and the drain of the MOS transistor Q15 is connected to a power supply negative electrode BAT− through a resistor R8.

Further, the one-key self-locking zero-power-consumption switch module is switched on and off by one key, and after shutdown, a circuit loop is disconnected, and a post-circuit is completely powered off.

Further, the USB control module can identify the bidirectional USB module through a single TYPE-C interface to charge and discharge the battery, and can automatically detect and identify charging or discharging.

Further, the controller is electrically connected with a TYPE-C socket; the controller is connected with a resistor R1 and a resistor R5; the other end of the resistor R1 is connected with a VCC; the other end of the resistor R5 is connected with a CBSB; a control unit MCU is connected with a capacitor C2, a resistor R8 and a resistor R7; the other ends of the capacitor C2 and the resistor R8 are connected with a GND; the other end of the resistor R7 is connected with a VBUS; the control unit MCU is electrically connected with a BOOST chip and a BUCK chip; the BOOST chip is electrically connected with a triode Q010; a pin 2 of the BOOST chip is connected with a resistor R2 and then connected with the control unit MCU; a pin 1 of the BOOST chip is connected with a capacitor C23 and a capacitor C27 in parallel; the pin 1 of the BOOST chip is connected with a pin 3 of the triode Q010; a pin 2 of the triode Q010 is connected with a resistor R60, a capacitor C26 and BT+; the other ends of the resistor R60 and the capacitor C26 are connected with a pin 1 of the triode Q010; the pin 1 of the triode Q010 is connected with a resistor R64 and a triode Q14; a base of the triode Q14 is connected with a resistor R76; the other ends of the capacitor C23 and the capacitor C27 are connected with an emitter of the triode Q14; the emitter of the triode Q14 is connected with a resistor R77; the other ends of the resistor R76 and the resistor R77 are connected with a DICR; a pin 2 of the BUCK chip is connected with a resistor R10 and a resistor R6 and then connected with the control unit MCU; the resistor R6 is connected with a resistor R11 in series; the resistor R11 is connected with a capacitor C4 in parallel; the resistor R11 and the capacitor C4 are connected with the GND; a pin 1 and a pin 3 of the BUCK chip are connected in series through a resistor R3, and the pin 1 is connected with a triode Q09; a pin 3 of the triode Q09 is connected with a capacitor C41 and a capacitor C42; a pin 2 of the triode Q09 is connected with a resistor R026, a capacitor C031 and the VBUS; the other ends of the resistor R026 and the capacitor C031 are connected with a pin 1 of the triode Q09; the pin 1 of the triode Q09 is connected with a resistor R81 and a triode Q15; a base of the triode Q15 is connected with a resistor R79; the other end of the resistor R79 is connected with a CH-SW;

A pin 8 of the BOOST chip is connected with an inductor L2; the other end of the inductor L2 is connected with a capacitor C30 and a resistor R57; the other end of the resistor R57 is connected with a capacitor C31, a pin 3 of the BOOST chip, a capacitor C24, a resistor R61 and the VBUS; the other end of the resistor R61 is connected with a capacitor C32;

A pin 7 of the BOOST chip is connected with a capacitor C21; the other end of the capacitor C21 is connected with a resistor R53; the other end of the resistor R53 is connected with a capacitor C22; the other end of the capacitor C22 is connected with the GND;

A pin 9 of the BOOST chip is connected with the GND; a pin 6 of the BOOST chip is connected with a capacitor C28; a pin 5 of the BOOST chip is connected with a resistor R63, a resistor R59 and a resistor R67; the other end of the resistor R59 is connected with a capacitor C29; the other ends of the capacitor C29 and the resistor R67 are connected with the capacitor C32;

A pin 6 of the BUCK chip is connected with the GND; a pin 4 of the BUCK chip is connected with a capacitor C3; the other end of the capacitor C3 is connected with the GND; the pin 2 of the BUCK chip is connected with a resistor R4; the other end of the resistor R4 is connected with a resistor R80; the other end of the resistor R80 is connected with an emitter of the triode Q15 and the resistor R80; the other end of the resistor R80 is connected with the base of the triode Q15;

A pin 1 of the BUCK chip is connected with an inductor L1; the other end of the inductor L1 is connected with a diode D1 and a rectifier triode M4; a pin 4 of the rectifier triode M4 is connected with a pin 5 of the BUCK chip; a pin 1, a pin 2 and a pin 3 of the rectifier triode M4 are connected with a capacitor C1; the other end of the capacitor C1 is connected with an output end of the diode D1; an output end of the diode D1 is connected with a capacitor C40, a resistor R13 and a triode Q11; the other ends of the capacitor C40 and the resistor R13 and a base of the triode Q11 are connected with a resistor R72 and a triode Q13; an emitter of the triode Q13 is connected with the GND; a base of the triode Q13 is connected with a resistor R74 and a resistor R73; the other end of the resistor R73 is connected with a VIN;

The pin 2 of the BUCK chip is connected with a resistor R9, the other end of the resistor R9 is connected with a diode D3, and an input end of the diode D3 is connected with the DICR.

Further, the emergency start power supply can identify the disconnection state of pins when a male connector is not inserted, to complete plugging and unplugging detection of the male connector of the TYPE-C socket, so that avoid battery energy waste caused by that a product control circuit is in a reactive operating state when a USB is in idle insertion without load.

Further, the emergency start power supply is connected with a delayer, two clamping heads are installed in the box body assembly, and the delayer is in communication with wires where the clamping heads are located and is in communication with the battery balance management module; the delayer is used for identifying the voltage of an electrified means of transportation; when the clamping heads are correctly connected with the outside, the delayer releases large-current output after time delay, and when the clamping heads are incorrectly connected with the outside, the emergency start power supply does not operate.

Further, the delayer comprises a chip, a triode and a resistor;

When the delayer is operated in delay, a buzzer on a control board generates a prompt tone;

When the delay deadline of the delayer expires, the relay is automatically closed to output large current, and after the clamping heads are disconnected from the outside, the output function of the relay is automatically closed.

Further, during operation, the delayer detects the starting state of the externally connected means of transportation in real time; when the voltage generated after the externally connected means of transportation is started is greater than the internal voltage of the emergency start power supply, the delayer feeds information back to the battery balance management module, and the battery balance management module controls the relay to disconnect the relay to stop large-flow output.

Further, the battery balance management module controls the on/off of the relay in an intermittent mode.

Further, the box body assembly comprises a box body and a box cover rotatably connected to an upper end of the box body.

Further, the emergency start power supply is provided with a USB connection socket, and the USB connection socket comprises a USB-A socket and a TYPE-C socket.

Further, the top of the emergency start power supply is also provided with a display screen, a switch, a power supply socket and AC sockets.

Further, the battery is installed in the battery shell composed of the battery upper shell and the battery lower shell; the battery shell is installed in an outer shell composed of an upper shell and a lower shell; the emergency start power supply further comprises a fan, a copper wiring terminal, an LED circuit board, a power supply socket cover, AC socket covers, a USB cover, an inverter circuit board, a socket upper shell, a positive electrode female plug assembly, a negative electrode female plug assembly, a socket lower shell, a battery flex cable, a clamping head, a negative electrode male plug assembly and a positive electrode male plug assembly; the number of the AC sockets is two; the power supply socket cover is used for covering the power supply socket; the AC socket covers are used for covering the AC sockets; and the USB cover is used for covering the USB connection socket.

The present invention has the following beneficial effects: the emergency start power supply with the large-capacity battery is adopted in the present invention for use together with the air pump module and the inverter module, has the USB fast charging and fast discharging functions, and also has the functions of zero-current-consumption circuit design, battery expansion detection, and three-stage temperature detection protection, so that the emergency start power supply can cope with various situations encountered during use, form setting or detection for various situations, and form an effective feedback and coping mechanism.

### BRIEF DESCRIPTION OF THE DRAWINGS

FIG. 1 is a system block diagram of the present invention;

FIG. 2A-1 is a partial circuit diagram of a controller of the present invention;

FIG. 2A-2 is a partial circuit diagram of a controller of the present invention;

FIG. 2A-3 is a partial circuit diagram of a controller of the present invention;

FIG. 2A-4 is a partial circuit diagram of a controller of the present invention;

FIG. 3 is a circuit diagram of an LED illuminating lamp of the present invention;

FIG. 4 is a circuit diagram of an LED lamp switch module of the present invention;

FIG. 5 is a circuit diagram of a battery temperature detection module of the present invention;

FIG. 6 is a circuit diagram of a buzzer of the present invention;

FIG. 7 is a circuit diagram of a power and information display module of the present invention;

FIG. 8 is a circuit diagram of a charging control module of the present invention;

FIG. 9 is a circuit diagram of an automobile battery voltage detection module of the present invention;

FIG. 10 is a circuit diagram of a battery bulging detection module of the present invention;

FIG. 11 is a circuit diagram of a one-key self-locking zero-power-consumption switch module of the present invention;

FIG. 12A-1 is a partial circuit diagram of a bidirectional USB module and a USB control module of the present invention;

FIG. 12A-2 is a partial circuit diagram of a bidirectional USB module and a USB control module of the present invention;

FIG. 12A-3 is a partial circuit diagram of a bidirectional USB module and a USB control module of the present invention;

FIG. 12A-4 is a partial circuit diagram of a bidirectional USB module and a USB control module of the present invention;

FIG. 12A-5 is a partial circuit diagram of a bidirectional USB module and a USB control module of the present invention;

FIG. 12A-6 is a partial circuit diagram of a bidirectional USB module and a USB control module of the present invention;

FIG. 13 is a circuit diagram of a charging control module of the present invention;

FIG. 14A-1 is a partial circuit diagram of a battery balance management module of the present invention;

FIG. 14A-2 is a partial circuit diagram of a battery balance management module of the present invention;

FIG. 15 is a circuit diagram of a start output module of the present invention;

FIG. 16 is a circuit diagram of a battery low-temperature heating control module of the present invention;

FIG. 17A-1 is a partial circuit diagram of an air pump module of the present invention;

FIG. 17A-2 is a partial circuit diagram of an air pump module of the present invention;

FIG. 18A-1 is a partial circuit diagram of an inverter module of the present invention;

FIG. 18A-2 is a partial circuit diagram of an inverter module of the present invention;

FIG. 18A-3 is a partial circuit diagram of an inverter module of the present invention;

FIG. 18A-4 is a partial circuit diagram of an inverter module of the present invention;

FIG. 18A-5 is a partial circuit diagram of an inverter module of the present invention;

FIG. 18A-6 is a partial circuit diagram of an inverter module of the present invention;

FIG. 18A-7 is a partial circuit diagram of an inverter module of the present invention;

FIG. 18A-8 is a partial circuit diagram of an inverter module of the present invention;

FIG. 18A-9 is a partial circuit diagram of an inverter module of the present invention;

FIG. 19 is an overall structural schematic diagram of the present invention; and

FIG. 20 is an exploded schematic diagram of the present invention.

In the figures: 1—box body assembly, 1.1—box body, 1.2—box cover, 2—emergency start power supply, 3—battery, 4—display screen, 5—switch, 6—power supply socket, 7—AC socket, 8—battery shell, 8.1—battery upper shell, 8.2—battery lower shell, 9—outer shell, 9.1—upper shell, 9.2—lower shell, 10—fan, 11—copper wiring terminal, 12—LED circuit board, 13—power supply socket cover, 14—AC socket cover, 15—USB cover, 16—inverter circuit board, 17—socket upper shell, 18—positive electrode female plug assembly, 19—negative electrode female plug assembly, 20—socket lower shell, 21—battery flex cable, 22—clamping head, 23—negative electrode male plug assembly, 24—positive electrode male plug assembly, 25—automotive battery voltage detection module, 26—one-key self-locking zero-power-consumption switch module, 27—battery balance management module, 28—temperature protection control module, 29—battery bulging detection module, 30—start output module, 31—bidirectional USB module, 32—LED illuminating lamp, 33—LED lamp switch module, 34—power and information display module, 35—fuse module, 36—voltage detection control module, 37—on/off management module, 38—charging monitoring module, 39—battery low-temperature heating control module, 40—battery temperature detection module, 41—start control module, 42—USB control module, 43—charging control module, 44—LED illuminating lamp control module, 45—power and information display control module, 46—controller, 47—bulging detection control module, 48—air pump module, 49—inverter module, 50—air pump data detection and communication module, 51—inverter data detection and communication module, and 52—USB connection socket.

### Description of Embodiments

In order to understand the technical solution of the present invention more intuitively and completely, the non-restrictive features are described as follows in combination with the drawings of the present invention:

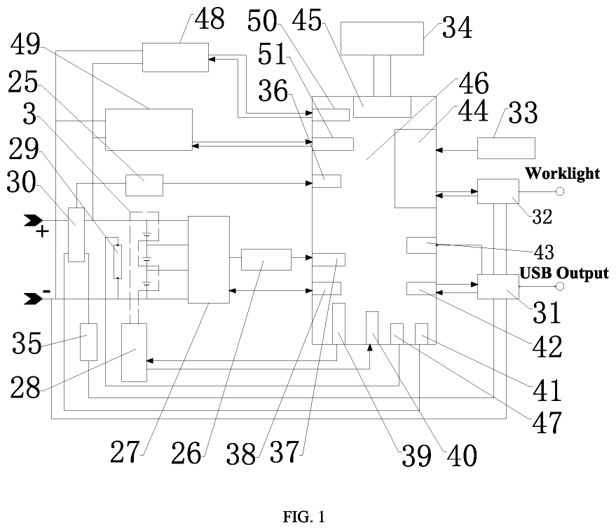

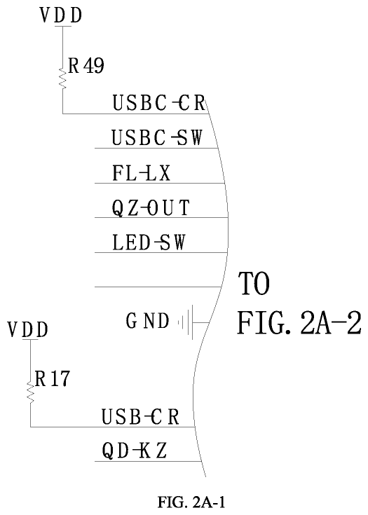

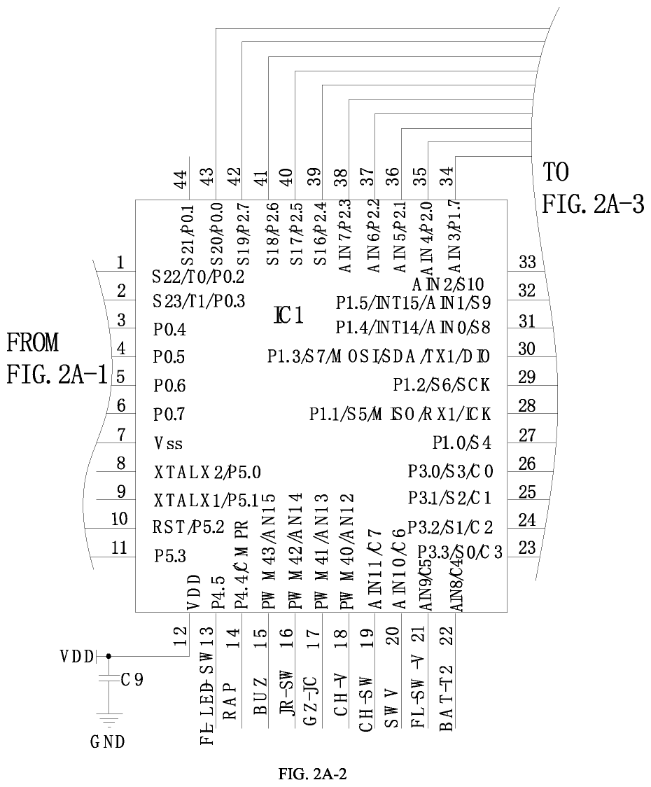

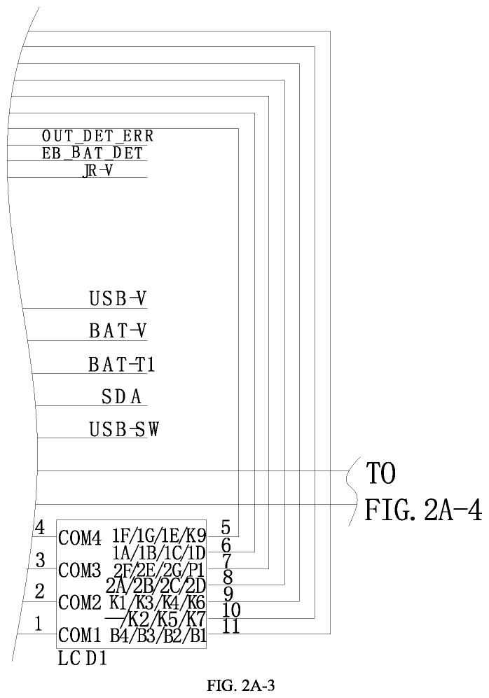

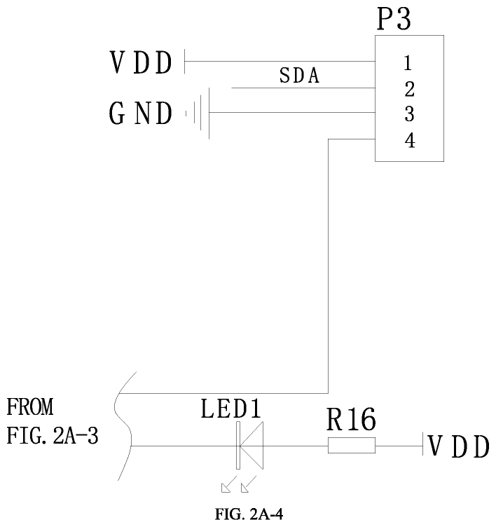

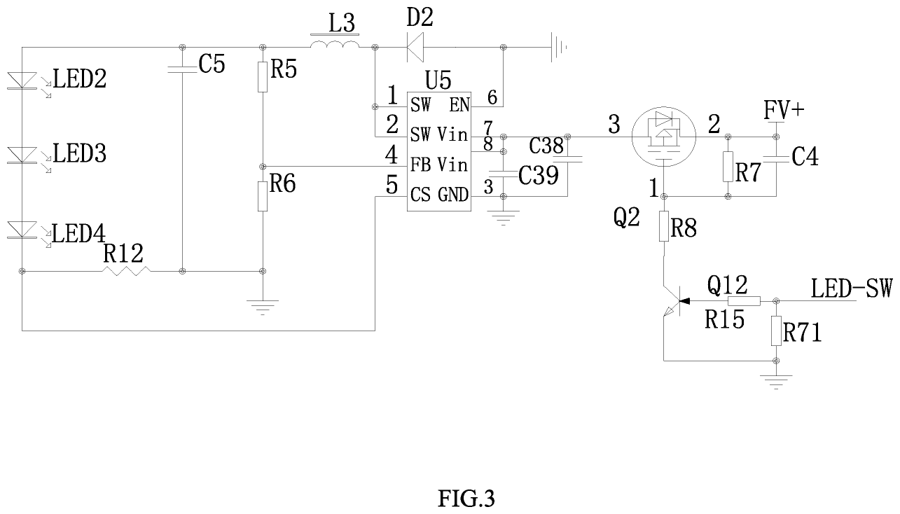

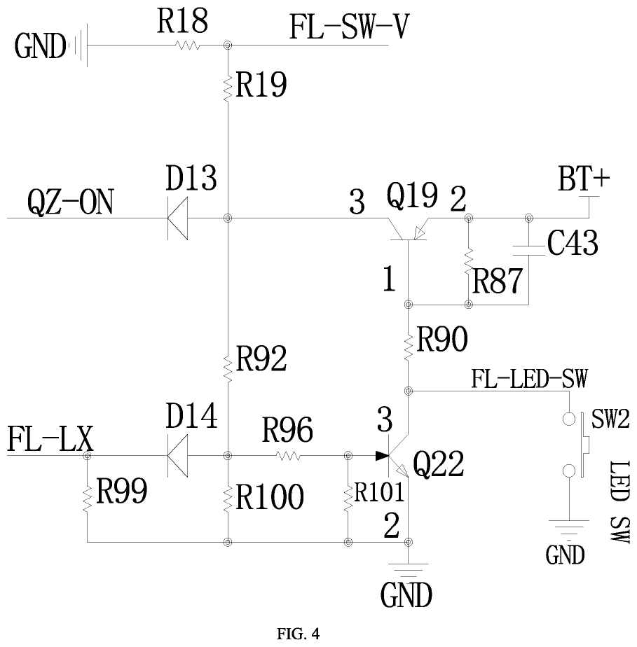

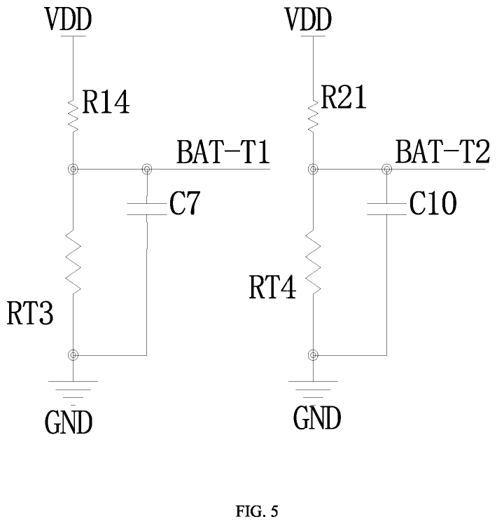

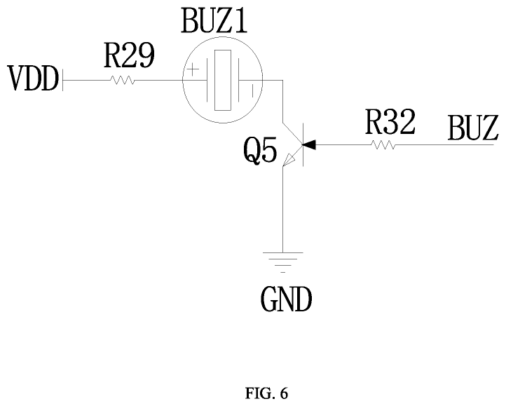

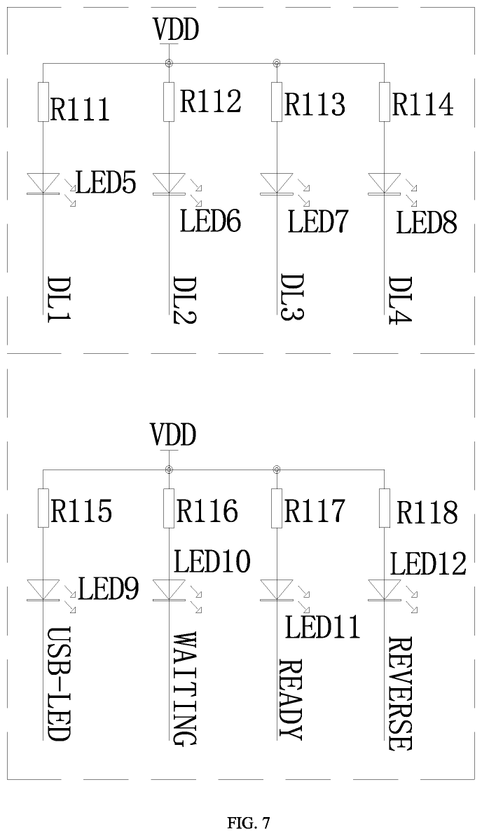

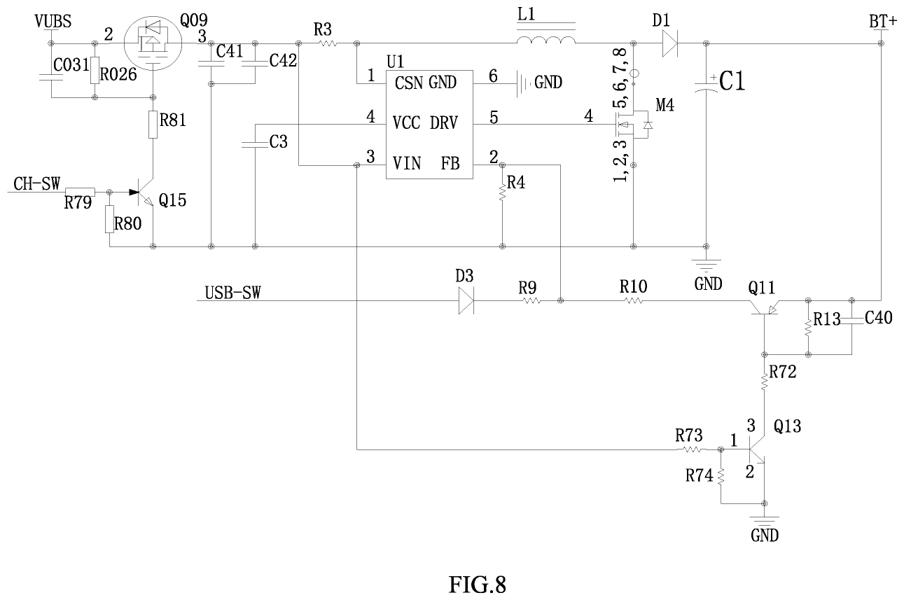

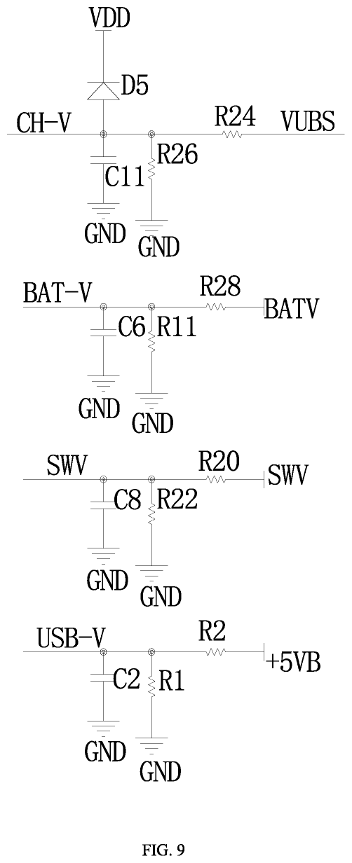

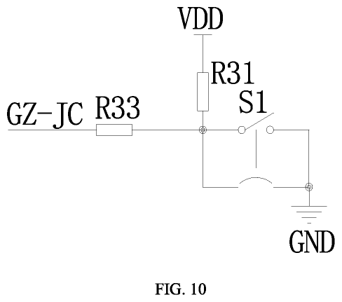

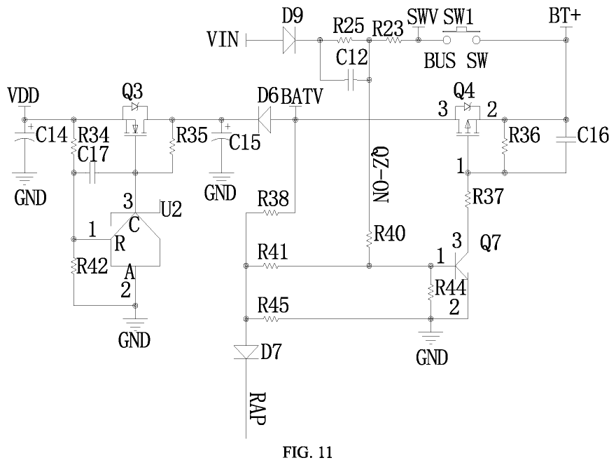

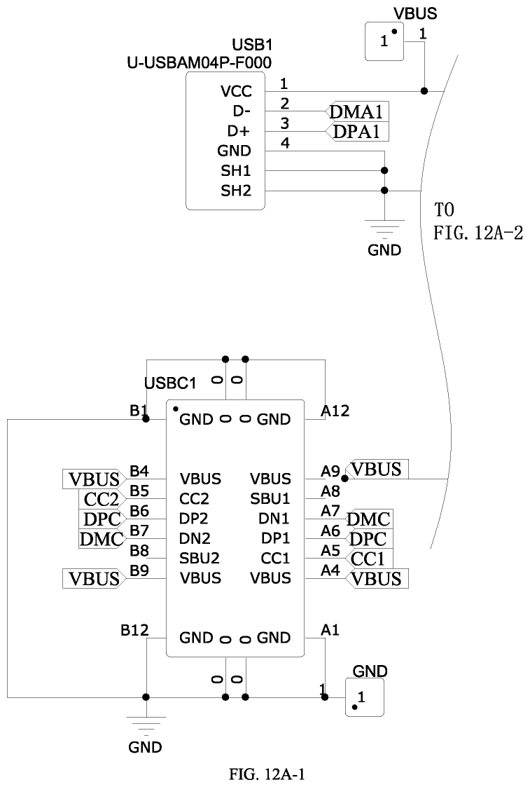

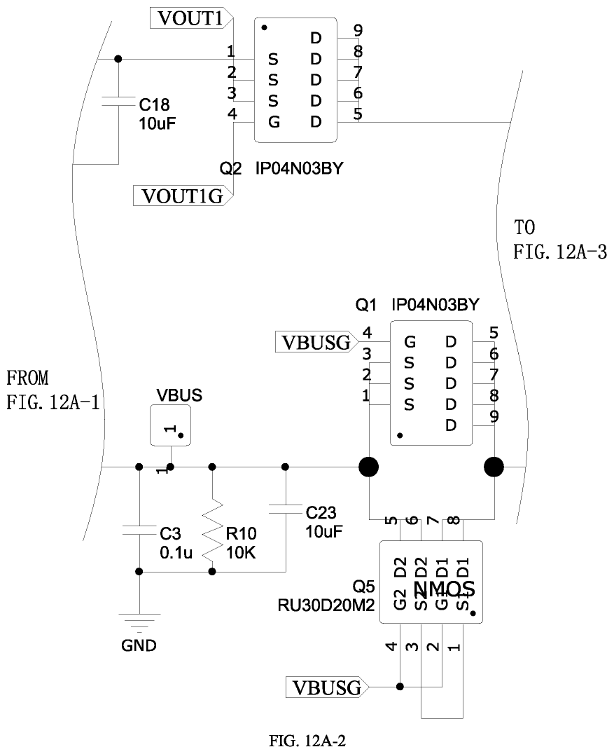

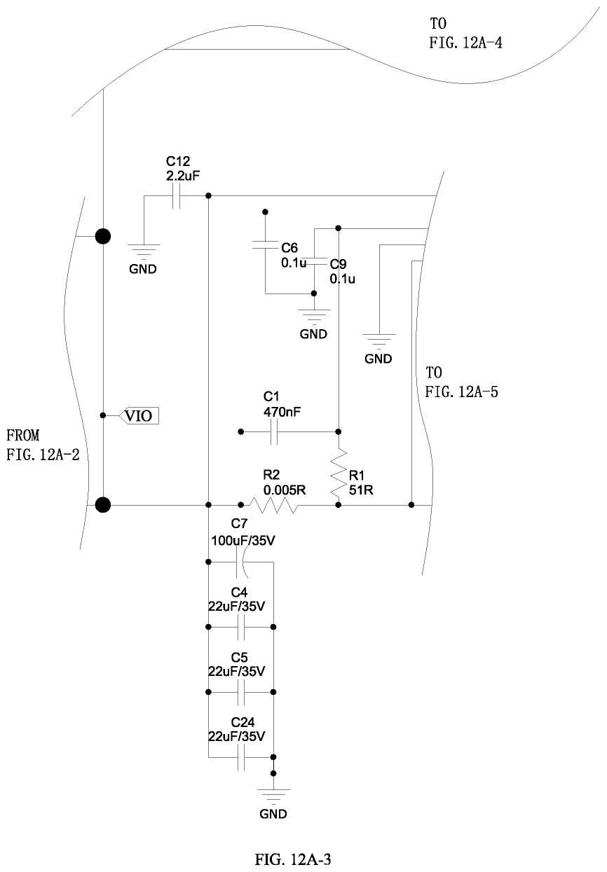

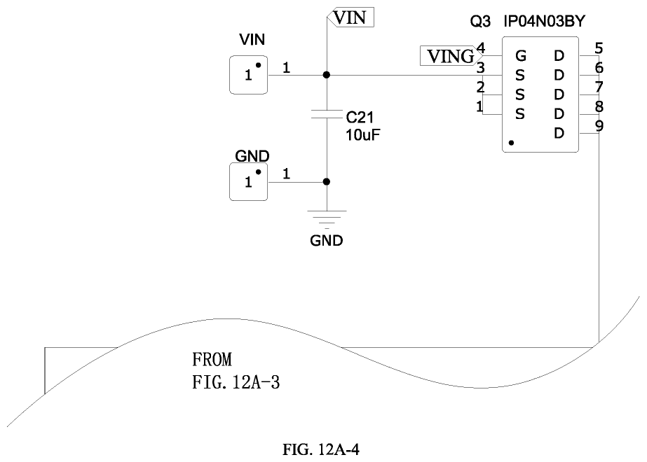

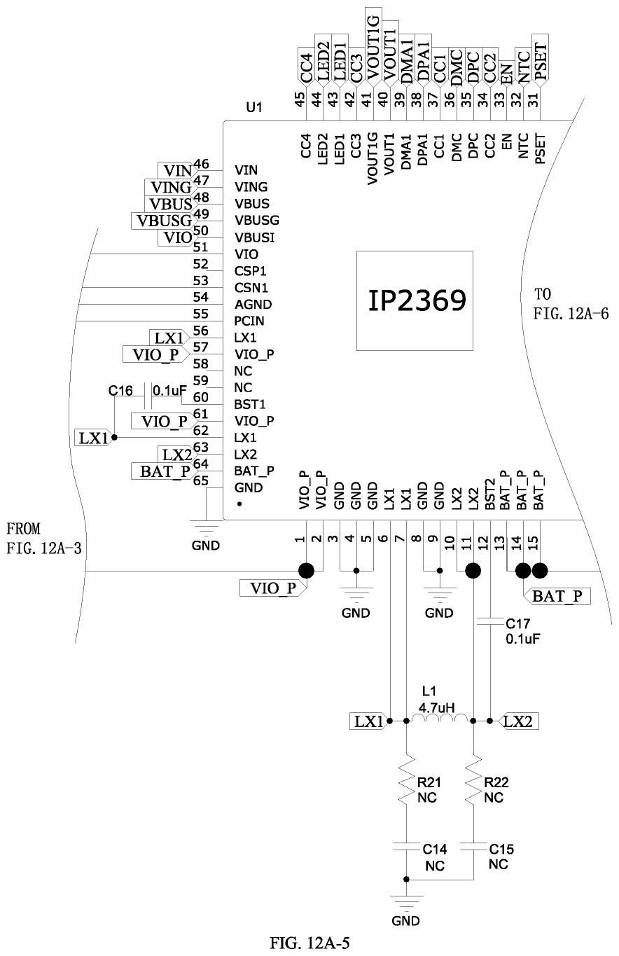

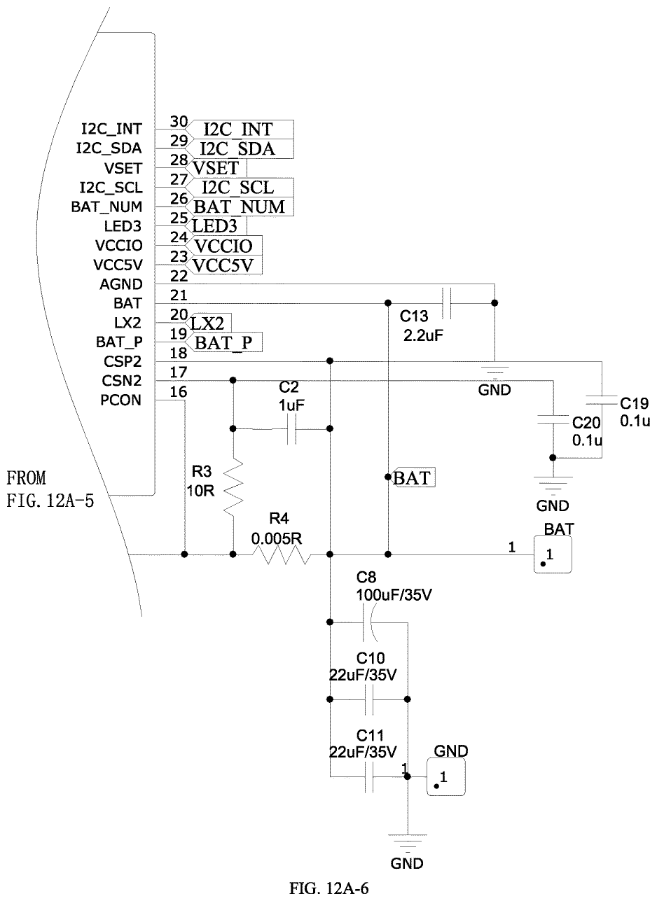

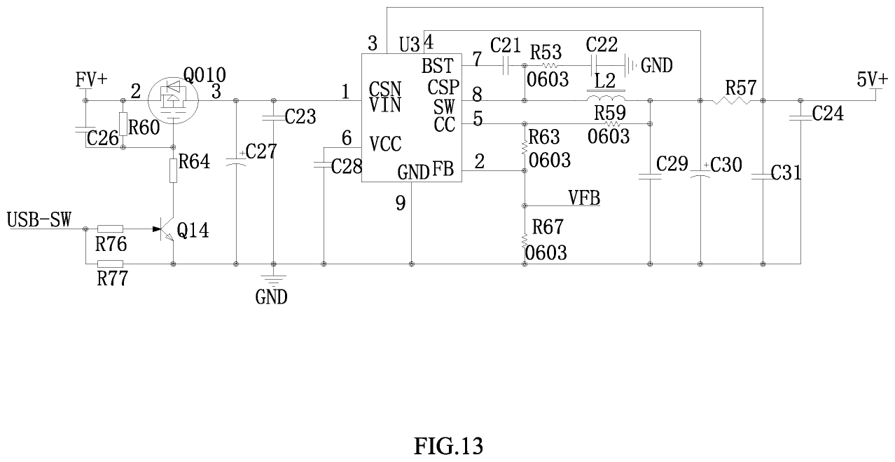

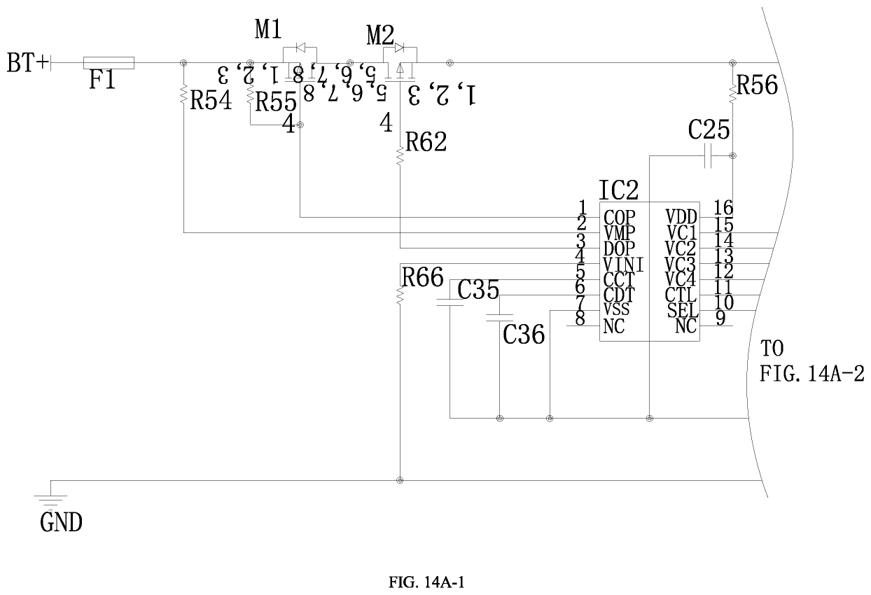

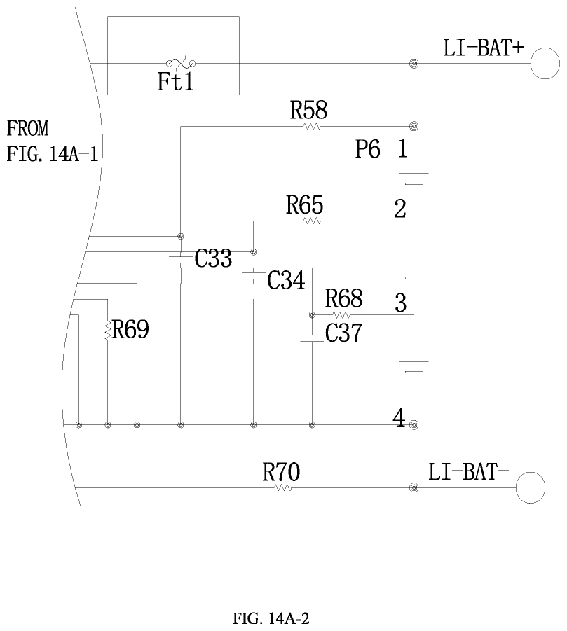

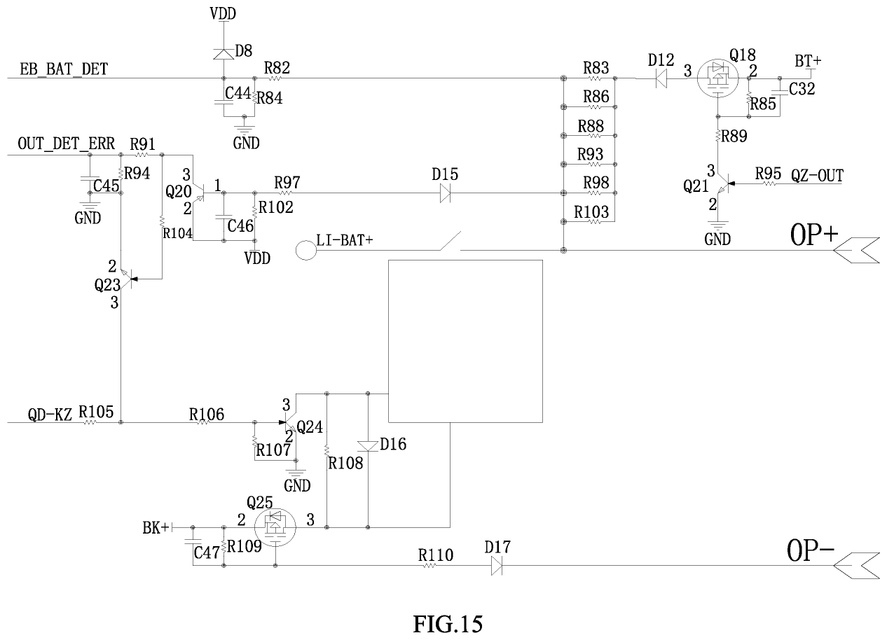

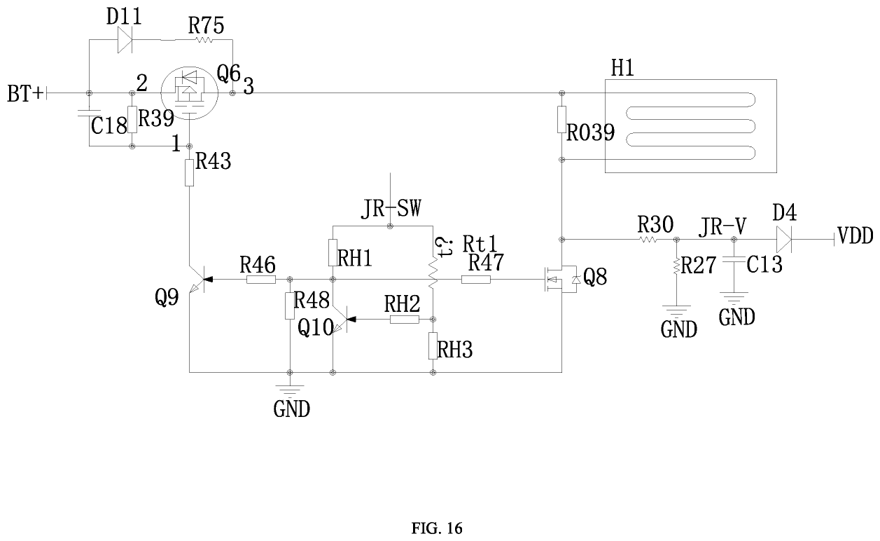

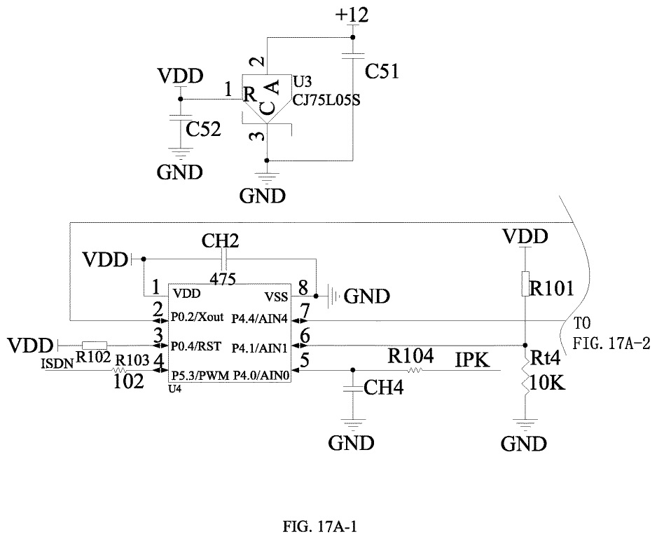

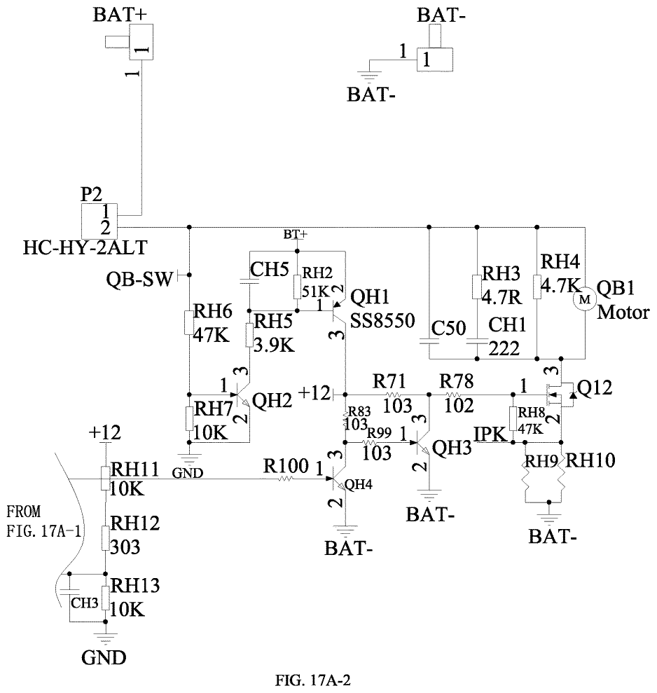

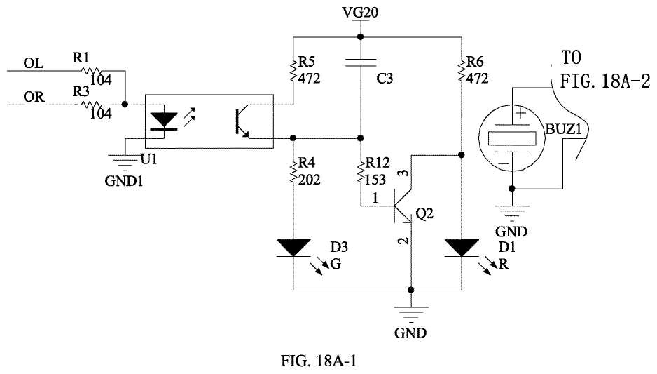

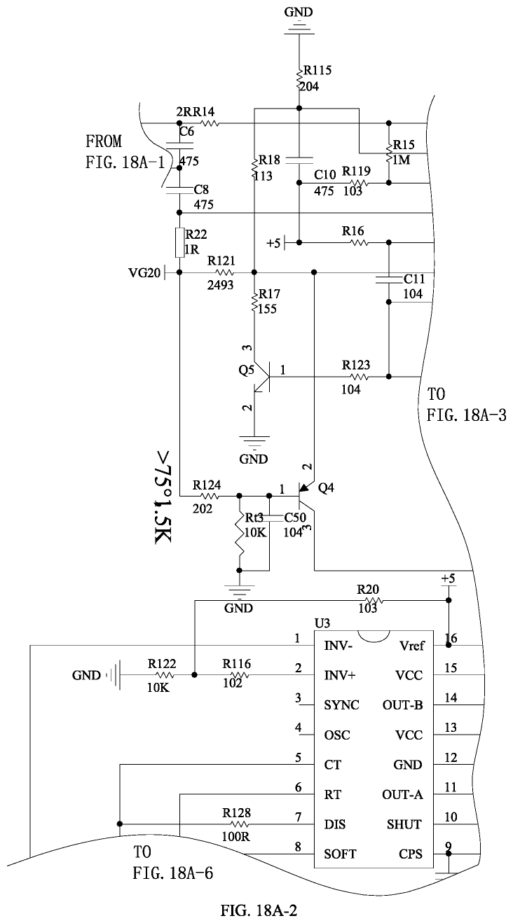

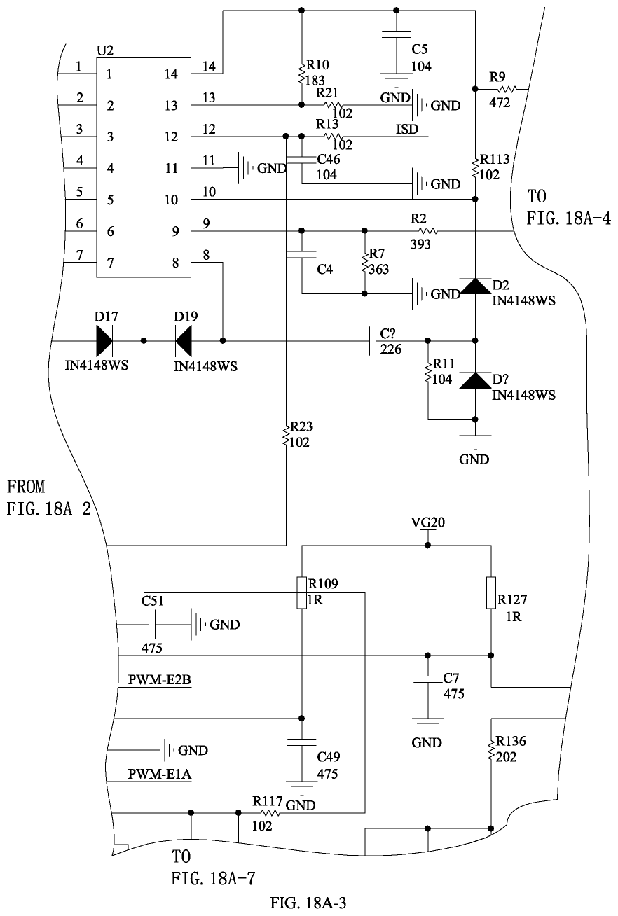

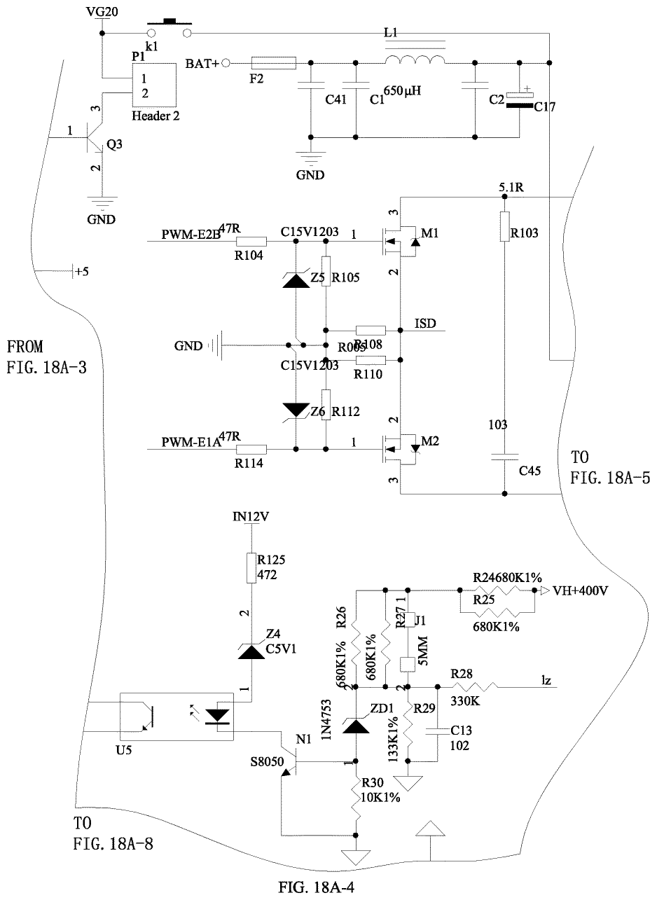

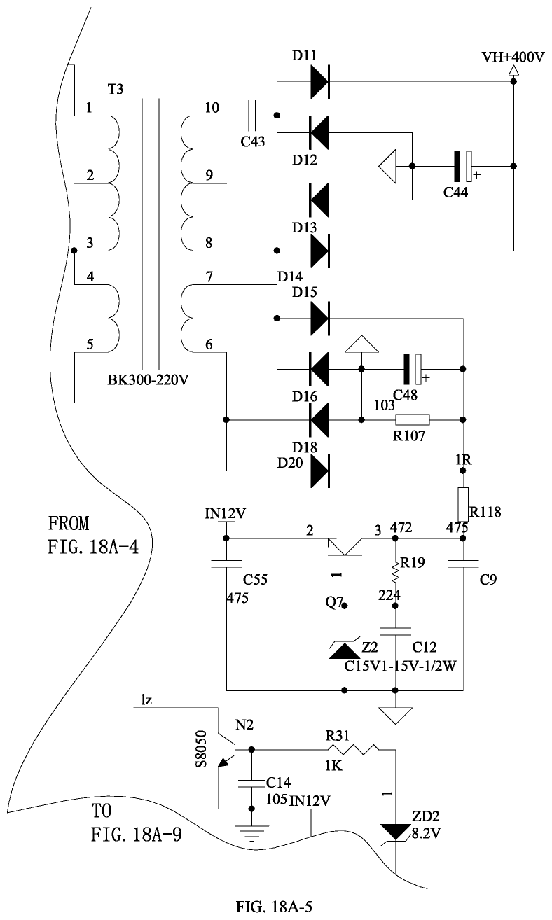

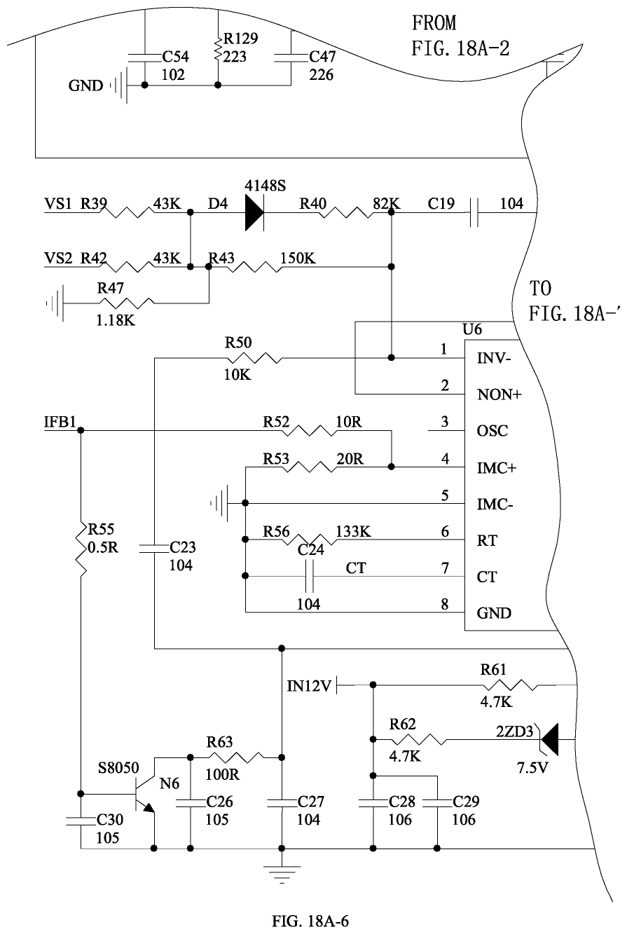

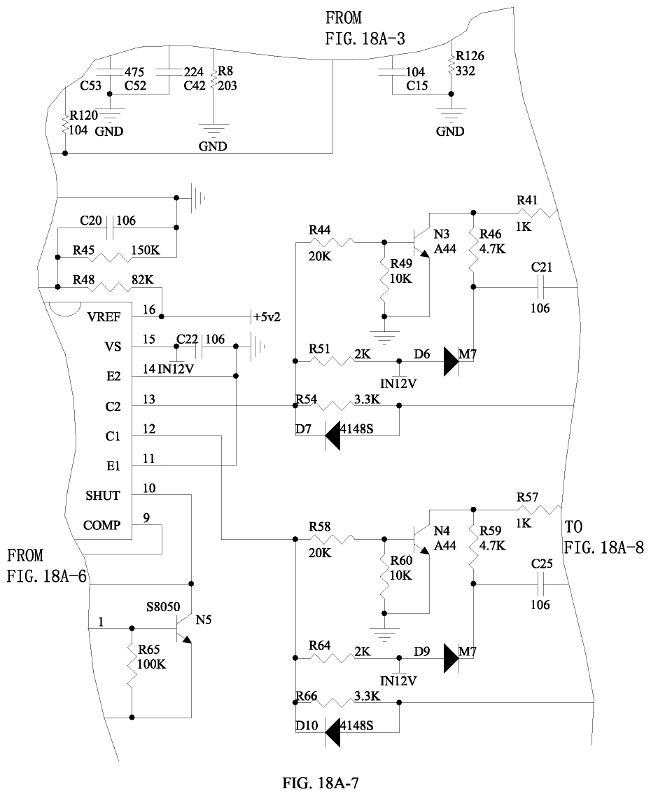

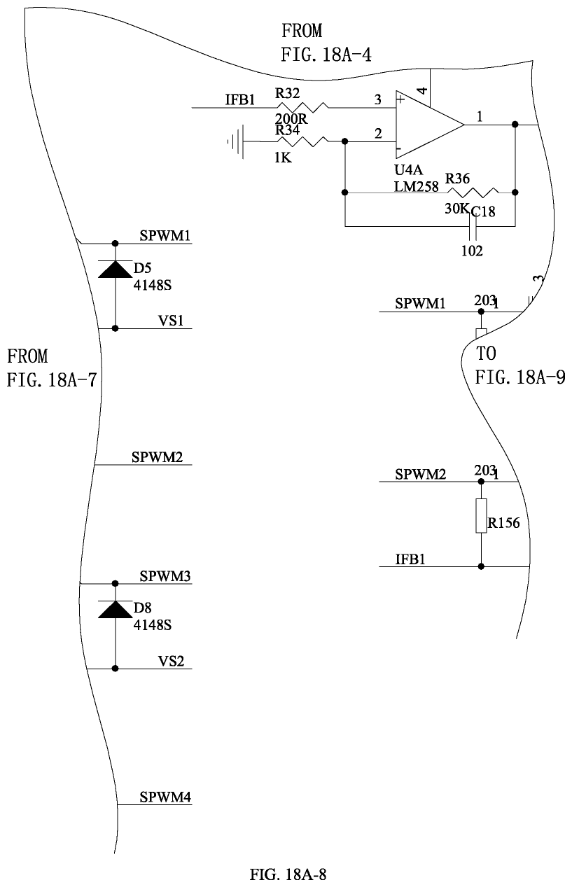

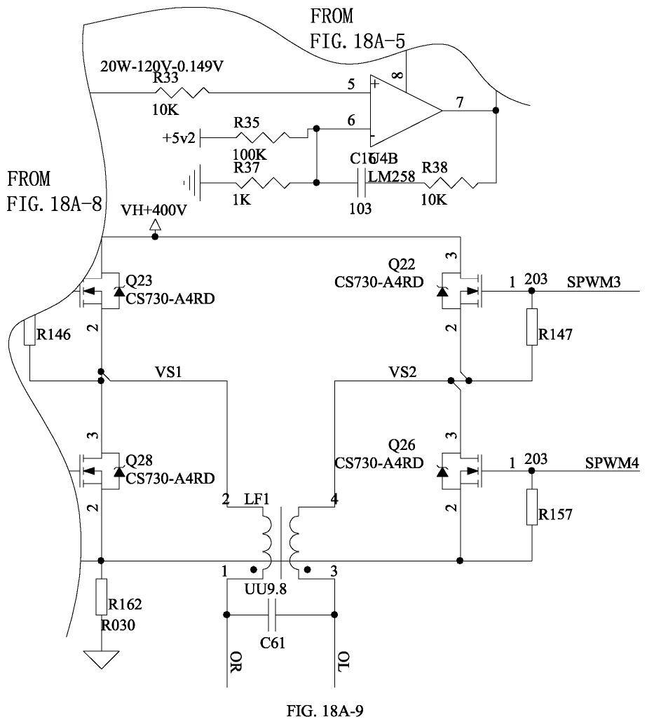

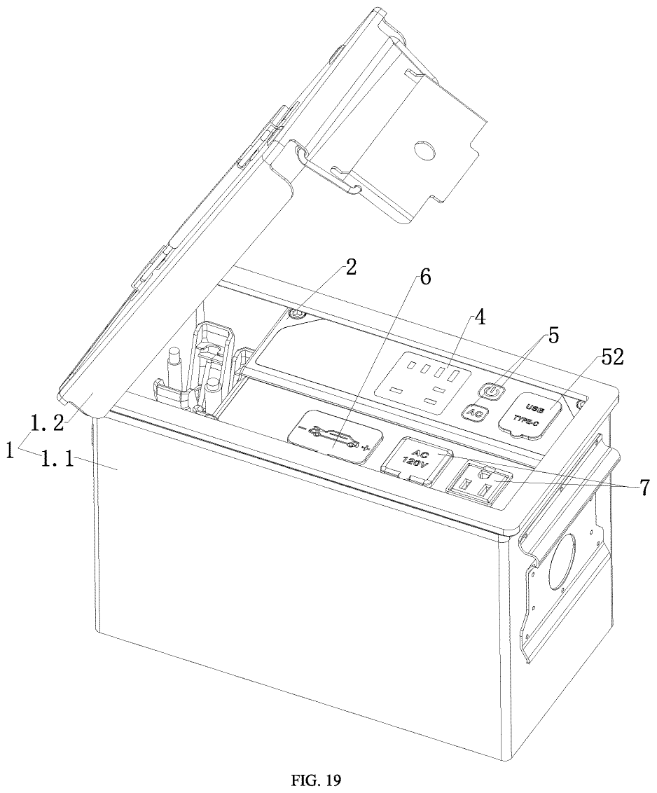

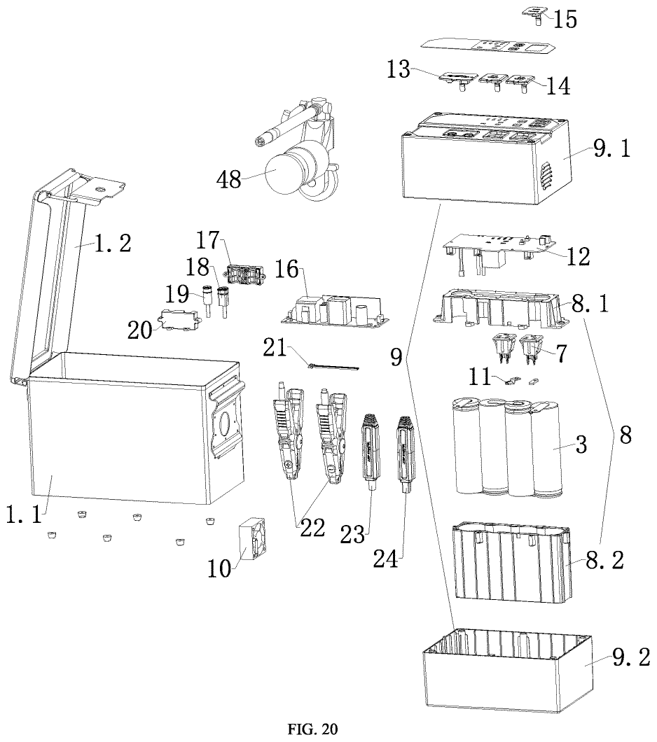

As shown in FIG. 1 to FIG. 20, a mobile power supply comprises a box body assembly 1, an emergency start power supply 2 is installed in the box body assembly 1, the emergency start power supply 2 is provided with an air pump module 48 and an inverter module 49, a large-capacity battery 3 is arranged in the emergency start power supply 2, and the emergency start power supply 2 is provided with a bidirectional USB module 31 capable of fast charging and fast discharging.

The mobile power supply comprises a controller 46; the controller 46 is connected with an automobile battery voltage detection module 25, a one-key self-locking zero-power-consumption switch module 26, a battery balance management module 27, a temperature protection control module 28, a battery bulging detection module 29, a start output module 30, the bidirectional USB module 31, an LED illuminating lamp 32, an LED lamp switch module 33, a power and information display module 34, the inverter module 49 and the air pump module 48; the automobile battery voltage detection module 25 is connected with the start output module 30; the start output module 30 is connected with a fuse module 35; the fuse module 35 is connected with the bidirectional USB module 31; the battery balance management module 27 is connected with the one-key self-locking zero-power-consumption switch module 26; and the battery 3 is connected with the battery balance management module 27, the battery bulging detection module 29, the temperature protection control module 28, the inverter module 49 and the air pump module 48.

The controller 46 is provided with a voltage detection control module 36, and an input end of the voltage detection control module 36 is connected with an output end of the automobile battery voltage detection module 25; the controller 46 is provided with an on/off management module 37, and an input end of the on/off management module 37 is connected with an output end of the one-key self-locking zero-power-consumption switch module 26; the controller 46 is provided with a charging monitoring module 38, and the charging monitoring module 38 is connected with the battery balance management module 27; the controller 46 is provided with a battery low-temperature heating control module 39 and a battery temperature detection module 40, an output end of the battery low-temperature heating control module 39 is connected with an input end of the temperature protection control module 28, and an input end of the battery temperature detection module 40 is connected with an output end of the temperature protection control module 28; the controller 46 is provided with a start control module 41, and the start control module 41 is connected with the start output module 30; the controller 46 is provided with a USB control module 42, a charging control module 43 and an LED illuminating lamp control module 44; the USB control module 42 and the charging control module 43 are connected with the bidirectional USB module 31; the LED illuminating lamp 32 is connected with the bidirectional USB module 31; an input end of the LED illuminating lamp control module 44 is connected with an output end of the LED lamp switch module 33; the controller 46 is provided with a power and information display control module 45, and the power and information display control module 45 is connected with the power and information display module 34; the controller 46 is provided with a bulging detection control module 47, and the bulging detection control module 47 is connected with the battery bulging detection module 29; the controller 46 is provided with an air pump data detection and communication module 50, and the air pump data detection and communication module 50 is connected with the air pump module 48; and the controller 46 is provided with an inverter data detection and communication module 51, and the inverter data detection and communication module 51 is connected with the inverter module 49.

The controller 46 has a magnetization function; the battery 3 controls output through a relay switch with a magnetization function driven by the controller 46; after a positive electrode and a negative electrode of the emergency start power supply 2 are correctly connected with an automobile, large current can be outputted and a magnetic field after the large current is generated can be optimally demagnetized; and magnetic steel is arranged inside a relay.

The emergency start power supply 2 is switched on and off through detection of battery voltage.

The battery temperature detection module 40 comprises three temperature detection units, and the temperature detection units are attached to a surface of the battery to perform multi-stage detection and protection on the battery.

The three temperature detection units are a first temperature detection unit, a second temperature detection unit and a third temperature detection unit; and when the first temperature detection unit monitors that battery temperature reaches a set value, the battery temperature detection module 40 transmits a signal to the battery balance management module 27, and the battery balance management module 27 controls and adjusts the output power of the battery.

When the first temperature detection unit loses a function due to an uncontrollable reason and the battery temperature reaches the set value, the second temperature detection unit starts a monitoring function and feeds back to the battery balance management module 27.

When both the first temperature detection unit and the second temperature detection unit lose functions, the third temperature detection unit starts to operate, and once monitoring that the battery temperature reaches the set value, the third temperature detection unit automatically cuts off the output function of the emergency start power supply 2, serves as a fuse of the emergency start power supply 2, and is non-recoverable.

No matter whether the temperature of the battery 3 reaches the set value due to charging, discharging or low temperature, after the battery balance management module 27 receives information that the temperature fed back by the first temperature detection unit or the second temperature detection unit reaches the set value, the battery balance management module issues an instruction to stop external output or internal input of the emergency start power supply 2, and automatically recovers the input or output function after the temperature of the battery 3 returns to a normal range.

The battery low-temperature heating control module 39 comprises heating plates arranged between surfaces of the battery 3, and the heating plates are connected to a positive electrode and a negative electrode of the battery through the battery balance management module 27; and the heating plates are attached to an outer surface of the battery 3 and have flame-retardant and insulating properties.

After the battery balance management module 27 receives low-temperature feedback, the battery low-temperature heating control module 39 starts to operate; the heating plates start to generate heat; and when the temperature of the battery 3 reaches a set required value for normal operation, the battery low-temperature heating control module 39 stops operating.

The battery bulging detection module 29 comprises a first sheet metal and a second sheet metal; the battery 3 is installed in a battery shell 8 composed of a battery upper shell 8.1 and a battery lower shell 8.2; the first sheet metal is fixed on an upper surface of the battery 3; the second sheet metal is fixed on an inner wall of the battery upper shell 8.1; when the first sheet metal is in contact with the second sheet metal, the feedback is sent to the battery balance management module 27; the battery balance management module 27 determines that the battery 3 expands and bulges, and timely stops the input or output function of the emergency start power supply; and the stopping behavior is non-recoverable.

The one-key self-locking zero-power-consumption switch module 26 automatically closes all input and output functions when the emergency start power supply 2 stops operating, so as to achieve zero-current energy consumption. The one-key self-locking zero-power-consumption switch module 26 comprises: a key switch circuit, a shutdown detection circuit, a self-locking loop circuit and a main control module; the key switch circuit comprises a key SW3, the key SW3 is connected with a power supply positive electrode BAT+, and the shutdown detection circuit is connected in series between the power supply positive electrode BAT+and an input end of the main control module through the key SW3; the self-locking loop circuit comprises an MOS tube Q15, a triode Q16, a resistor R84, a resistor R85 and a resistor R87; a collector of the triode Q16 is connected with a gate of the MOS tube Q15 through the resistor R84; a source of the MOS tube Q15 is connected with the power positive pole BAT+; the resistor R85 and the resistor R87 connected in series successively are connected between a drain of the MOS tube Q15 and the triode Q16 to form a self-locking loop; a common end of the resistor R85 and the resistor R87 is connected to an output end of the main control module;

The key SW3 is connected to the base of the triode Q16 through a voltage dividing resistor, and when the key SW3 is pressed, the triode Q16 is saturated and conducted, and the MOS transistor is conducted to achieve start; and when the key SW3 is pressed again, the shutdown detection circuit detects voltage and transmits the voltage to the main control module, the main control module controls the output end to output a low voltage level, the triode Q16 is cut off, and the MOS transistor Q15 is cut off to complete shutdown.

The on/off management module 37 comprises a resistor R78, a resistor R79 and a capacitor C41, the resistor R78 is connected in series between the input end of the main control module and the key SW3, and the resistor R79 and the capacitor C41 are both connected in parallel between the input end of the main control module and the ground;

A resistor R83 and a capacitor C43 are connected in parallel between the grid and the source of the MOS transistor Q15;

An emitter of the triode Q16 is grounded, and a resistor R88 is connected in series between the base and the emitter of the triode Q16 ; a resistor R89 is connected in series between the common end of the resistor R85 and the resistor R87 and the ground;

The drain of the MOS transistor Q15 is connected to a VDD end of the main control module through a diode D12, and the drain of the MOS transistor Q15 is connected to a power supply negative electrode BAT− through a resistor R8.

The one-key self-locking zero-power-consumption switch module 26 is switched on and off by one key, and after shutdown, a circuit loop is disconnected, and a post-circuit is completely powered off.

The USB control module 42 can identify the bidirectional USB module 31 through a single TYPE-C interface to charge and discharge the battery, and can automatically detect and identify charging or discharging.

The controller 46 is electrically connected with a TYPE-C socket; the controller 46 is connected with a resistor R1 and a resistor R5; the other end of the resistor R1 is connected with a VCC; the other end of the resistor R5 is connected with a CBSB; a control unit MCU is connected with a capacitor C2, a resistor R8 and a resistor R7; the other ends of the capacitor C2 and the resistor R8 are connected with a GND; the other end of the resistor R7 is connected with a VBUS; the control unit MCU is electrically connected with a BOOST chip and a BUCK chip; the BOOST chip is electrically connected with a triode Q010; a pin 2 of the BOOST chip is connected with a resistor R2 and then connected with the control unit MCU; a pin 1 of the BOOST chip is connected with a capacitor C23 and a capacitor C27 in parallel; the pin 1 of the BOOST chip is connected with a pin 3 of the triode Q010; a pin 2 of the triode Q010 is connected with a resistor R60, a capacitor C26 and BT+; the other ends of the resistor R60 and the capacitor C26 are connected with a pin 1 of the triode Q010; the pin 1 of the triode Q010 is connected with a resistor R64 and a triode Q14; a base of the triode Q14 is connected with a resistor R76; the other ends of the capacitor C23 and the capacitor C27 are connected with an emitter of the triode Q14; the emitter of the triode Q14 is connected with a resistor R77; the other ends of the resistor R76 and the resistor R77 are connected with a DICR; a pin 2 of the BUCK chip is connected with a resistor R10 and a resistor R6 and then connected with the control unit MCU; the resistor R6 is connected with a resistor R11 in series; the resistor R11 is connected with a capacitor C4 in parallel; the resistor R11 and the capacitor C4 are connected with the GND; a pin 1 and a pin 3 of the BUCK chip are connected in series through a resistor R3, and the pin 1 is connected with a triode Q09; a pin 3 of the triode Q09 is connected with a capacitor C41 and a capacitor C42; a pin 2 of the triode Q09 is connected with a resistor R026, a capacitor C031 and the VBUS; the other ends of the resistor R026 and the capacitor C031 are connected with a pin 1 of the triode Q09; the pin 1 of the triode Q09 is connected with a resistor R81 and a triode Q15; a base of the triode Q15 is connected with a resistor R79; the other end of the resistor R79 is connected with a CH-SW;

A pin 8 of the BOOST chip is connected with an inductor L2; the other end of the inductor L2 is connected with a capacitor C30 and a resistor R57; the other end of the resistor R57 is connected with a capacitor C31, a pin 3 of the BOOST chip, a capacitor C24, a resistor R61 and the VBUS; the other end of the resistor R61 is connected with a capacitor C32;

A pin 7 of the BOOST chip is connected with a capacitor C21; the other end of the capacitor C21 is connected with a resistor R53; the other end of the resistor R53 is connected with a capacitor C22; the other end of the capacitor C22 is connected with the GND;

A pin 9 of the BOOST chip is connected with the GND; a pin 6 of the BOOST chip is connected with a capacitor C28; a pin 5 of the BOOST chip is connected with a resistor R63, a resistor R59 and a resistor R67; the other end of the resistor R59 is connected with a capacitor C29; the other ends of the capacitor C29 and the resistor R67 are connected with the capacitor C32;

A pin 6 of the BUCK chip is connected with the GND; a pin 4 of the BUCK chip is connected with a capacitor C3; the other end of the capacitor C3 is connected with the GND; the pin 2 of the BUCK chip is connected with a resistor R4; the other end of the resistor R4 is connected with a resistor R80; the other end of the resistor R80 is connected with an emitter of the triode Q15 and the resistor R80; the other end of the resistor R80 is connected with the base of the triode Q15;

A pin 1 of the BUCK chip is connected with an inductor L1; the other end of the inductor L1 is connected with a diode D1 and a rectifier triode M4; a pin 4 of the rectifier triode M4 is connected with a pin 5 of the BUCK chip; a pin 1, a pin 2 and a pin 3 of the rectifier triode M4 are connected with a capacitor C1; the other end of the capacitor C1 is connected with an output end of the diode D1; an output end of the diode D1 is connected with a capacitor C40, a resistor R13 and a triode Q11; the other ends of the capacitor C40 and the resistor R13 and a base of the triode Q11 are connected with a resistor R72 and a triode Q13; an emitter of the triode Q13 is connected with the GND; a base of the triode Q13 is connected with a resistor R74 and a resistor R73; the other end of the resistor R73 is connected with a VIN;

The pin 2 of the BUCK chip is connected with a resistor R9, the other end of the resistor R9 is connected with a diode D3, and an input end of the diode D3 is connected with the DICR.

The emergency start power supply can identify the disconnection state of pins when a male connector is not inserted, to complete plugging and unplugging detection of the male connector of the TYPE-C socket, so that avoid battery energy waste caused by that a product control circuit is in a reactive operating state when a USB is in idle insertion without load.

The emergency start power supply is connected with a delayer, two clamping heads are installed in the box body assembly, and the delayer is in communication with wires where the clamping heads are located and is in communication with the battery balance management module 27; the delayer is used for identifying the voltage of an electrified means of transportation; when the clamping heads are correctly connected with the outside, the delayer releases large-current output after time delay, and when the clamping heads are incorrectly connected with the outside, the emergency start power supply does not operate.

The delayer comprises a chip, a triode and a resistor;

When the delayer is operated in delay, a buzzer on a control board generates a prompt tone;

When the delay deadline of the delayer expires, the relay is automatically closed to output large current, and after the clamping heads are disconnected from the outside, the output function of the relay is automatically closed.

During operation, the delayer detects the starting state of the externally connected means of transportation in real time; when the voltage generated after the externally connected means of transportation is started is greater than the internal voltage of the emergency start power supply, the delayer feeds information back to the battery balance management module 27, and the battery balance management module 27 controls the relay to disconnect the relay to stop large-flow output.

The battery balance management module 27 controls the on/off of the relay in an intermittent mode.

The box body assembly 1 comprises a box body 1.1 and a box cover 1.2 rotatably connected to an upper end of the box body 1.1. The emergency start power supply 2 is provided with a USB connection socket 52, and the USB connection socket 52 comprises a USB-A socket and a TYPE-C socket.

The top of the emergency start power supply 2 is also provided with a display screen 4, a switch 5, a power supply socket 6 and AC sockets 7.

The battery 3 is installed in the battery shell 8 composed of the battery upper shell 8.1 and the battery lower shell 8.2; the battery shell 8 is installed in an outer shell 9 composed of an upper shell 9.1 and a lower shell 9.2; the emergency start power supply 2 further comprises a fan 10, a copper wiring terminal 11, an LED circuit board 12, a power supply socket cover 13, AC socket covers 14, a USB cover 15, an inverter circuit board 16, a socket upper shell 17, a positive electrode female plug assembly 18, a negative electrode female plug assembly 19, a socket lower shell 20, a battery flex cable 21, a clamping head 22, a negative electrode male plug assembly 23 and a positive electrode male plug assembly 24; the number of the AC sockets 7 is two; the power supply socket cover 13 is used for covering the power supply socket 6; the AC socket covers 14 are used for covering the AC sockets 7; and the USB cover 15 is used for covering the USB connection socket.

The emergency start power supply 2 with the large-capacity battery 3 is adopted in the present invention for use together with the air pump module 48 and the inverter module 49, has the USB fast charging and fast discharging functions, and also has the functions of zero-current-consumption circuit design, battery expansion detection, and three-stage temperature detection protection, so that the emergency start power supply can cope with various situations encountered during use, form setting or detection for various situations, and form an effective feedback and coping mechanism.

Of course, the above only describes the preferred embodiments of the present invention, and does not limit the scope of the patent of the present invention. All simple modifications and equivalent structural changes made by using the description and schematic content of the present invention shall be included within the protection scope of the patent of the present invention in the same way.

What is claimed is:

1. A mobile power supply, comprising a box body assembly, wherein an emergency start power supply is installed in the box body assembly, the emergency start power supply is provided with an air pump module and an inverter module, a large-capacity battery is arranged in the emergency start power supply, and the emergency start power supply is provided with a bidirectional USB module capable of fast charging and fast discharging.

2. The mobile power supply according to claim 1, comprising a controller, wherein the controller is connected with an automobile battery voltage detection module, a one-key self-locking zero-power-consumption switch module, a battery balance management module, a temperature protection control module, a battery bulging detection module, a start output module, the bidirectional USB module, an LED illuminating lamp, an LED lamp switch module, a power and information display module, the inverter module and the air pump module; the automobile battery voltage detection module is connected with the start output module; the start output module is connected with a fuse module; the fuse module is connected with the bidirectional USB module; the battery balance management module is connected with the one-key self-locking zero-power-consumption switch module; and the battery is connected with the battery balance management module, the battery bulging detection module, the temperature protection control module, the inverter module and the air pump module.

3. The mobile power supply according to claim 2, wherein the controller is provided with a voltage detection control module, and an input end of the voltage detection control module is connected with an output end of the automobile battery voltage detection module; the controller is provided with an on/off management module, and an input end of the on/off management module is connected with an output end of the one-key self-locking zero-power-consumption switch module; the controller is provided with a charging monitoring module, and the charging monitoring module is connected with the battery balance management module; the controller is provided with a battery low-temperature heating control module and a battery temperature detection module, an output end of the battery low-temperature heating control module is connected with an input end of the temperature protection control module, and an input end of the battery temperature detection module is connected with an output end of the temperature protection control module; the controller is provided with a start control module, and the start control module is connected with the start output module; the controller is provided with a USB control module, a charging control module and an LED illuminating lamp control module; the USB control module and the charging control module are connected with the bidirectional USB module; the LED illuminating lamp is connected with the bidirectional USB module; an input end of the LED illuminating lamp control module is connected with an output end of the LED lamp switch module; the controller is provided with a power and information display control module, and the power and information display control module is connected with the power and information display module; the controller is provided with an air pump data detection and communication module, and the air pump data detection and communication module is connected with the air pump module; and the controller is provided with an inverter data detection and communication module, and the inverter data detection and communication module is connected with the inverter module.

4. The mobile power supply according to claim 3, wherein the controller has a magnetization function; the battery controls output through a relay switch with a magnetization function driven by the controller; after a positive electrode and a negative electrode of the emergency start power supply are correctly connected with an automobile, large current can be outputted and a magnetic field after the large current is generated can be optimally demagnetized; and magnetic steel is arranged inside a relay.

5. The mobile power supply according to claim 1, wherein the emergency start power supply is switched on and off through detection of battery voltage.

6. The mobile power supply according to claim 3, wherein the battery temperature detection module comprises three temperature detection units, and the temperature detection units are attached to a surface of the battery to perform multi-stage detection and protection on the battery.

7. The mobile power supply according to claim 6, wherein the three temperature detection units are a first temperature detection unit, a second temperature detection unit and a third temperature detection unit; and when the first temperature detection unit monitors that battery temperature reaches a set value, the battery temperature detection module transmits a signal to the battery balance management module, and the battery balance management module controls and adjusts the output power of the battery.

8. The mobile power supply according to claim 7, wherein when the first temperature detection unit loses a function due to an uncontrollable reason and the battery temperature reaches the set value, the second temperature detection unit starts a monitoring function and feeds back to the battery balance management module.

9. The mobile power supply according to claim 8, wherein when both the first temperature detection unit and the second temperature detection unit lose functions, the third temperature detection unit starts to operate, and once monitoring that the battery temperature reaches the set value, the third temperature detection unit automatically cuts off the output function of the emergency start power supply, serves as a fuse of the emergency start power supply, and is non-recoverable.

10. The mobile power supply according to claim 9, wherein no matter whether the battery temperature reaches the set value due to charging, discharging or low temperature, after the battery balance management module receives information that the temperature fed back by the first temperature detection unit or the second temperature detection unit reaches the set value, the battery balance management module issues an instruction to stop external output or internal input of the emergency start power supply, and automatically recovers the input or output function after the battery temperature returns to a normal range.

11. The mobile power supply according to claim 10, wherein the battery low-temperature heating control module comprises heating plates arranged between surfaces of the battery, and the heating plates are connected to a positive electrode and a negative electrode of the battery through the battery balance management module; and the heating plates are attached to an outer surface of the battery and have flame-retardant and insulating properties.

12. The mobile power supply according to claim 11, wherein after the battery balance management module receives low-temperature feedback, the battery low-temperature heating control module starts to operate; the heating plates start to generate heat; and when the battery temperature reaches a set required value for normal operation, the battery low-temperature heating control module stops operating.

13. The mobile power supply according to claim 12, wherein the battery bulging detection module comprises a first sheet metal and a second sheet metal; the battery is installed in a battery shell composed of a battery upper shell and a battery lower shell; the first sheet metal is fixed on an upper surface of the battery; the second sheet metal is fixed on an inner wall of the battery upper shell; when the first sheet metal is in contact with the second sheet metal, the feedback is sent to the battery balance management module; the battery balance management module determines that the battery expands and bulges, and timely stops the input or output function of the emergency start power supply; and the stopping behavior is non-recoverable.

14. The mobile power supply according to claim 3, wherein the one-key self-locking zero-power-consumption switch module automatically closes all input and output functions when the emergency start power supply stops operating, so as to achieve zero-current energy consumption.

15. The mobile power supply according to claim 14, wherein the one-key self-locking zero-power-consumption switch module comprises: a key switch circuit, a shutdown detection circuit, a self-locking loop circuit and a main control module; the key switch circuit comprises a key SW3, the key SW3 is connected with a power supply positive electrode BAT+, and the shutdown detection circuit is connected in series between the power supply positive electrode BAT+ and an input end of the main control module through the key SW3; the self-locking loop circuit comprises an MOS transistor Q15, a triode Q16, a resistor R84, a resistor R85 and a resistor R87; a collector of the triode Q16 is connected with a grid of the MOS transistor Q15 through the resistor R84; a source of the MOS transistor Q15 is connected with the power supply positive electrode BAT+; the resistor R85 and the resistor R87 which are connected in series in sequence are connected between a drain of the MOS transistor Q15 and a base of the triode Q16 to form a self-locking loop; a common end of the resistor R85 and the resistor R87 is connected to an output end of the main control module;
the key SW3 is connected to the base of the triode Q16 through a voltage dividing resistor, and when the key SW3 is pressed, the triode Q16 is saturated and conducted, and the MOS transistor is conducted to achieve start; and when the key SW3 is pressed again, the shutdown detection circuit detects voltage and transmits the voltage to the main control module, the main control module controls the output end to output a low voltage level, the triode Q16 is cut off, and the MOS transistor Q15 is cut off to complete shutdown.

16. The mobile power supply according to claim 15, wherein the on/off management module comprises a resistor R78, a resistor R79 and a capacitor C41, the resistor R78 is connected in series between the input end of the main control module and the key SW3, and the resistor R79 and the capacitor C41 are both connected in parallel between the input end of the main control module and the ground;
a resistor R83 and a capacitor C43 are connected in parallel between the grid and the source of the MOS transistor Q15;
an emitter of the triode Q16 is grounded, and a resistor R88 is connected in series between the base and the emitter of the triode Q16; a resistor R89 is connected in series between the common end of the resistor R85 and the resistor R87 and the ground;
the drain of the MOS transistor Q15 is connected to a VDD end of the main control module through a diode D12, and the drain of the MOS transistor Q15 is connected to a power supply negative electrode BAT− through a resistor R8.

17. The mobile power supply according to claim 16, wherein the one-key self-locking zero-power-consumption switch module is switched on and off by one key, and after shutdown, a circuit loop is disconnected, and a post-circuit is completely powered off.

18. The mobile power supply according to claim 3, wherein the USB control module can identify the bidirectional USB module through a single TYPE-C interface to charge and discharge the battery, and can automatically detect and identify charging or discharging.

19. The mobile power supply according to claim 18, wherein the controller is electrically connected with a TYPE-C socket; the controller is connected with a resistor R1 and a resistor R5; the other end of the resistor R1 is connected with a VCC; the other end of the resistor R5 is connected with a CBSB; a control unit MCU is connected with a capacitor C2, a resistor R8 and a resistor R7; the other ends of the capacitor C2 and the resistor R8 are connected with a GND; the other end of the resistor R7 is connected with a VBUS; the control unit MCU is electrically connected with a BOOST chip and a BUCK chip; the BOOST chip is electrically connected with a triode Q010; a pin 2 of the BOOST chip is connected with a resistor R2 and then connected with the control unit MCU; a pin 1 of the BOOST chip is connected with a capacitor C23 and a capacitor C27 in parallel; the pin 1 of the BOOST chip is connected with a pin 3 of the triode Q010; a pin 2 of the triode Q010 is connected with a resistor R60, a capacitor C26 and BT+; the other ends of the resistor R60 and the capacitor C26 are connected with a pin 1 of the triode Q010; the pin 1 of the triode Q010 is connected with a resistor R64 and a triode Q14; a base of the triode Q14 is connected with a resistor R76; the other ends of the capacitor C23 and the capacitor C27 are connected with an emitter of the triode Q14; the emitter of the triode Q14 is connected with a resistor R77; the other ends of the resistor R76 and the resistor R77 are connected with a DICR; a pin 2 of the BUCK chip is connected with a resistor R10 and a resistor R6 and then connected with the control unit MCU; the resistor R6 is connected with a resistor R11 in series; the resistor R11 is connected with a capacitor C4 in parallel; the resistor R11 and the capacitor C4 are connected with the GND; a pin 1 and a pin 3 of the BUCK chip are connected in series through a resistor R3, and the pin 1 is connected with a triode Q09; a pin 3 of the triode Q09 is connected with a capacitor C41 and a capacitor C42; a pin 2 of the triode Q09 is connected with a resistor R026, a capacitor C031 and the VBUS; the other ends of the resistor R026 and the capacitor C031 are connected with a pin 1 of the triode Q09; the pin 1 of the triode Q09 is connected with a resistor R81 and a triode Q15; a base of the triode Q15 is connected with a resistor R79; the other end of the resistor R79 is connected with a CH-SW;
a pin 8 of the BOOST chip is connected with an inductor L2; the other end of the inductor L2 is connected with a capacitor C30 and a resistor R57; the other end of the resistor R57 is connected with a capacitor C31, a pin 3 of the BOOST chip, a capacitor C24, a resistor R61 and the VBUS; the other end of the resistor R61 is connected with a capacitor C32;
a pin 7 of the BOOST chip is connected with a capacitor C21; the other end of the capacitor C21 is connected with a resistor R53; the other end of the resistor R53 is connected with a capacitor C22; the other end of the capacitor C22 is connected with the GND;
a pin 9 of the BOOST chip is connected with the GND; a pin 6 of the BOOST chip is connected with a capacitor C28; a pin 5 of the BOOST chip is connected with a resistor R63, a resistor R59 and a resistor R67; the other end of the resistor R59 is connected with a capacitor C29; the other ends of the capacitor C29 and the resistor R67 are connected with the capacitor C32;
a pin 6 of the BUCK chip is connected with the GND; a pin 4 of the BUCK chip is connected with a capacitor C3; the other end of the capacitor C3 is connected with the GND; the pin 2 of the BUCK chip is connected with a resistor R4; the other end of the resistor R4 is connected with a resistor R80; the other end of the resistor R80 is connected with an emitter of the triode Q15 and the resistor R80; the other end of the resistor R80 is connected with the base of the triode Q15;
a pin 1 of the BUCK chip is connected with an inductor L1; the other end of the inductor L1 is connected with a diode D1 and a rectifier triode M4; a pin 4 of the rectifier triode M4 is connected with a pin 5 of the BUCK chip; a pin 1, a pin 2 and a pin 3 of the rectifier triode M4 are connected with a capacitor C1; the other end of the capacitor C1 is connected with an output end of the diode D1; an output end of the diode D1 is connected with a capacitor C40, a resistor R13 and a triode Q11; the other ends of the capacitor C40 and the resistor R13 and a base of the triode Q11 are connected with a resistor R72 and a triode Q13; an emitter of the triode Q13 is connected with the GND; a base of the triode Q13 is connected with a resistor R74 and a resistor R73; the other end of the resistor R73 is connected with a VIN;
the pin 2 of the BUCK chip is connected with a resistor R9, the other end of the resistor R9 is connected with a diode D3, and an input end of the diode D3 is connected with the DICR.

20. The mobile power supply according to claim 19, wherein the emergency start power supply can identify the disconnection state of pins when a male connector is not inserted, to complete plugging and unplugging detection of the male connector of the TYPE-C socket, so that avoid battery energy waste caused by that a product control circuit is in a reactive operating state when a USB is in idle insertion without load.

21. The mobile power supply according to claim 3, wherein the emergency start power supply is connected with a delayer, two clamping heads are installed in the box body assembly, and the delayer is in communication with wires where the clamping heads are located and is in communication with the battery balance management module; the delayer is used for identifying the voltage of an electrified means of transportation; when the clamping heads are correctly connected with the outside, the delayer releases large-current output after time delay, and when the clamping heads are incorrectly connected with the outside, the emergency start power supply does not operate.

22. The mobile power supply according to claim 21, wherein the delayer comprises a chip, a triode and a resistor;
when the delayer is operated in delay, a buzzer on a control board generates a prompt tone;
when the delay deadline of the delayer expires, the relay is automatically closed to output large current, and after the clamping heads are disconnected from the outside, the output function of the relay is automatically closed.

23. The mobile power supply according to claim 22, wherein during operation, the delayer detects the starting state of the externally connected means of transportation in real time; when the voltage generated after the externally connected means of transportation is started is greater than the internal voltage of the emergency start power supply, the delayer feeds information back to the battery balance management module, and the battery balance management module controls the relay to disconnect the relay to stop large-flow output.

24. The mobile power supply according to claim 23, wherein the battery balance management module controls the on/off of the relay in an intermittent mode.

25. The mobile power supply according to claim 1, wherein the box body assembly comprises a box body and a box cover rotatably connected to an upper end of the box body.

26. The mobile power supply according to claim 25, wherein the top of the emergency start power supply is provided with a USB connection socket, and the USB connection socket comprises a USB-A socket and a TYPE-C socket.

27. The mobile power supply according to claim 25, wherein the top of the emergency start power supply is also provided with a display screen, a switch, a power supply socket and AC sockets.

28. The mobile power supply according to claim 26, wherein the battery is installed in the battery shell composed of the battery upper shell and the battery lower shell; the battery shell is installed in an outer shell composed of an upper shell and a lower shell; the emergency start power supply further comprises a fan, a copper wiring terminal, an LED circuit board, a power supply socket cover, AC socket covers, a USB cover, an inverter circuit board, a socket upper shell, a positive electrode female plug assembly, a negative electrode female plug assembly, a socket lower shell, a battery flex cable, a clamping head, a negative electrode male plug assembly and a positive electrode male plug assembly; the number of the AC sockets is two;
the power supply socket cover is used for covering the power supply socket; the AC socket covers are used for covering the AC sockets; and the USB cover is used for covering the USB connection socket.
